(19) United States
(12) Patent Application Publication
(10) Pub. No.: US 2011/0025683 A1
(43) Pub. Date: Feb. 3, 2011

(54) Map Display Device

(75) Inventor: Hisao Takagi, Kanagawa (JP)

Correspondence Address: CROWELL & MORING LLP;INTELLECTUAL PROPERTY GROUP, P.O. BOX 14300, WASHINGTON, DC, 20044-4300, US

(73) Assignee: Clarion Co., Ltd., Bunkyo-ku, Tokyo (JP)

(21) Appl. No.: 12/936,305

(22) PCT Filed: Apr. 4, 2008
(86) PCT No.: PCT/JP2008/056784

§ 371 Date: Oct. 4, 2010

(51) Int. Cl. G06T 1/00

(52) U.S. Cl. 345/418

(57) ABSTRACT

A map display device includes: a map display control unit that displays a map at a display monitor; a weather information reception unit that receives weather information; and a weather information display control unit that displays the received weather information by superimposing the weather information over the map, wherein: if a plurality of sets of weather information for a plurality of geographical areas are allocated to a map area corresponding to a single pixel at the display monitor, a set of weather information for a geographical area with weather information thereof indicating a largest weather information numerical value, among the plurality of sets of weather information for the plurality of geographical areas, is displayed at the single pixel.

### TECHNICAL FIELD

The present invention relates to a map display device that brings up on display weather information superimposed over a map.

### BACKGROUND ART

There are map display devices known in the related art that indicate the amounts of rainfall for various geographical areas at corresponding positions on a map with the amounts of rainfall being obtained from a weather information center (see, for instance, patent reference 1).

Patent reference 1 Japanese Laid Open Patent Publication No. 2003-121172

### DISCLOSURE OF THE INVENTION

### Problems to be Solved by the Invention

There is an issue yet to be addressed in a map display device such as that disclosed in patent reference 1 in how the amounts of rainfall for various geographical areas, obtained from the weather information center, may be optimally indicated on a wide-range map on display.

### Means for Solving the Problems

A map display device according to the present invention comprises: a map display control unit that displays a map at a display monitor; a weather information reception unit that receives weather information; and a weather information display control unit that displays the received weather information by superimposing the weather information over the map, wherein: if a plurality of sets of weather information for a plurality of geographical areas are allocated to a map area corresponding to a single pixel at the display monitor, a set of weather information for a geographical area with weather information thereof indicating a largest weather information numerical value, among the plurality of sets of weather information for the plurality of geographical areas, is displayed at the single pixel. It is preferred that the map display device further comprises: a weather information extraction unit that extracts weather information for a display range of the display monitor among the weather information received at the weather information reception unit, wherein: the weather information display control unit displays weather information superimposed over the map based upon the extracted weather information, and displays weather information superimposed over the map based upon weather information having been extracted while the map is being scrolled. The weather information indicates cumulative precipitation, wind direction, wind speed, temperature, humidity, duration of sunshine per unit time, barometric pressure or humidity.

### EFFECT OF THE INVENTION

According to the present invention, if weather information for a plurality of geographical areas is available over a map area corresponding to a single pixel at the display monitor, the weather information for the geographical area with the weather information thereof indicating a largest weather information numerical value, among the plurality of sets of weather information for the plurality of geographical areas, is displayed over the particular pixel. Thus, the processing for displaying detailed weather information by superimposing the weather information over a wide-range map can be speeded up.

### BRIEF DESCRIPTION OF THE DRAWINGS

FIG. 1 A block diagram showing the structure of the navigation system achieved in an indictment of the present invention.

FIG. 2 An illustration of the screen resolution at the display monitor

FIG. 3 Weather information provided through a satellite radio broadcast

FIG. 4 An illustration of the precipitation display data processing executed in an embodiment of the present invention

FIG. 5 A method that may be adopted when determining the precipitation data to be displayed over a given pixel at the display monitor

FIG. 6 A flow chart of the precipitation display data processing executed in the embodiment of the present invention

FIG. 7 A method that may be adopted when determining the precipitation data to be displayed over the individual pixels at the display monitor when scrolling the map

FIG. 8 A method that may be adopted when determining the precipitation data to be displayed over the individual pixels at the display monitor when scrolling the map

FIG. 9 A method that may be adopted when determining the precipitation data to be displayed over the individual pixels at the display monitor when scrolling the map

### BEST MODE FOR CARRYING OUT THE INVENTION

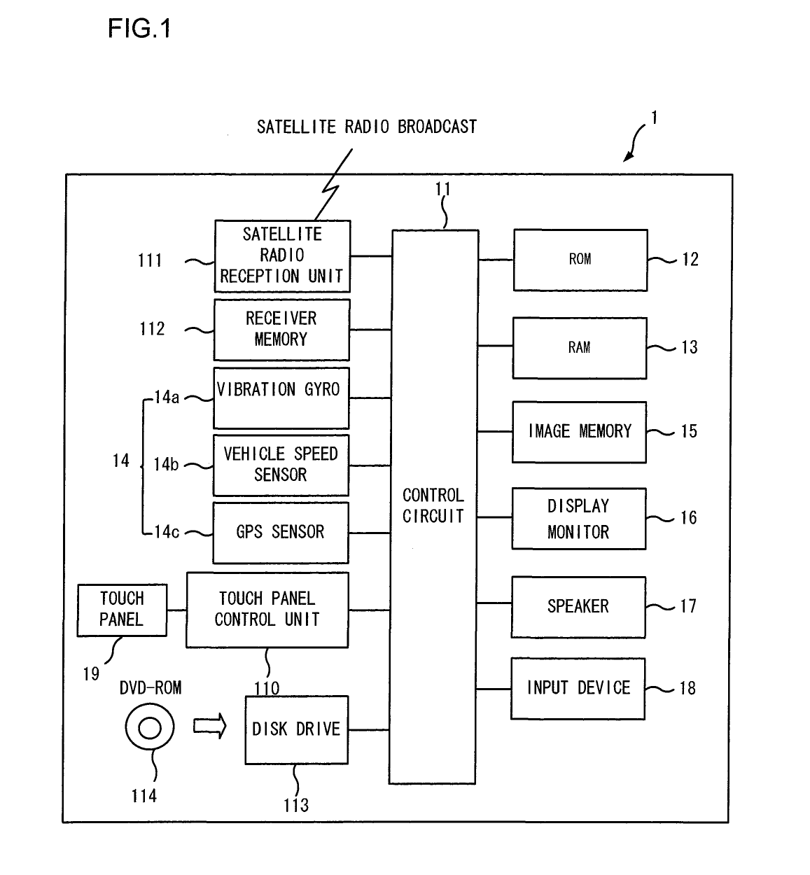

FIG. 1 shows a navigation system 1 achieved in an embodiment of the present invention. The navigation system 1 is capable of displaying weather information received through a satellite radio broadcast by superimposing the weather information over a map on display at a display monitor 16. Satellite radio broadcasters in the known art include, for instance, Sirius Satellite Radio. The navigation system 1 comprises a control circuit 11, a ROM 12, a RAM 13, a current position detection device 14, an image memory 15, the display monitor 16, a speaker 17, an input device 18, a touch panel 19, a touch panel control unit 110, a satellite radio reception unit 111, a receiver memory 112 and a disk drive 113. A DVD-ROM 114 with map data stored therein is loaded into the disk drive 113.

The control circuit 11, constituted with a microprocessor and its peripheral circuits, executes various types of control as it executes a control program stored in the ROM 12 by using the RAM 13 as a work area. The results of a specific type of route search processing executed by the control circuit 11 based upon the map data stored in the DVD-ROM 114 are brought up on display as a recommended route at the display monitor 16.

The current position detection device 14 detects the current location of the vehicle. The current position detection device 14 is constituted with a vibration gyro 14a, a vehicle speed sensor 14b, a GPS (global positioning system) sensor 14c and the like. The vibration gyro 14a detects the direction along which the vehicle is advancing. The vehicle speed sensor 14b detects the vehicle speed. The GPS sensor 14c detects GPS signals transmitted from GPS satellites. Based upon the current location of the vehicle detected by the current position detection device 14, the navigation system 1 determines an optimal map display range, a route search start point and the like. In addition, it indicates the current vehicle position as a subject vehicle position mark on the map.

In the image memory 15, image data to be displayed at the display monitor 16 are stored. Such image data include roadmap drawing data and various types of graphics data. These image data are generated by the control circuit 11 as needed based upon the map data stored in the DVD-ROM 114 and the like. The navigation system 1 is able to provide a map display and the like by using the image data thus generated.

The disk drive 113 reads out map data from the DVD-ROM 114. The map data include map display data and route search data. The map display data and the route search data include link information and node information related to the roads in the map data. The map display data include map data at seven different scaling factors from wide-range through detailed. The scaling factor of the map on display can be thus adjusted to one of the seven different levels in response to a user request. It is to be noted that map data may be read out via a recording medium other than the DVD ROM 114, such as a CD-ROM or a hard disk.

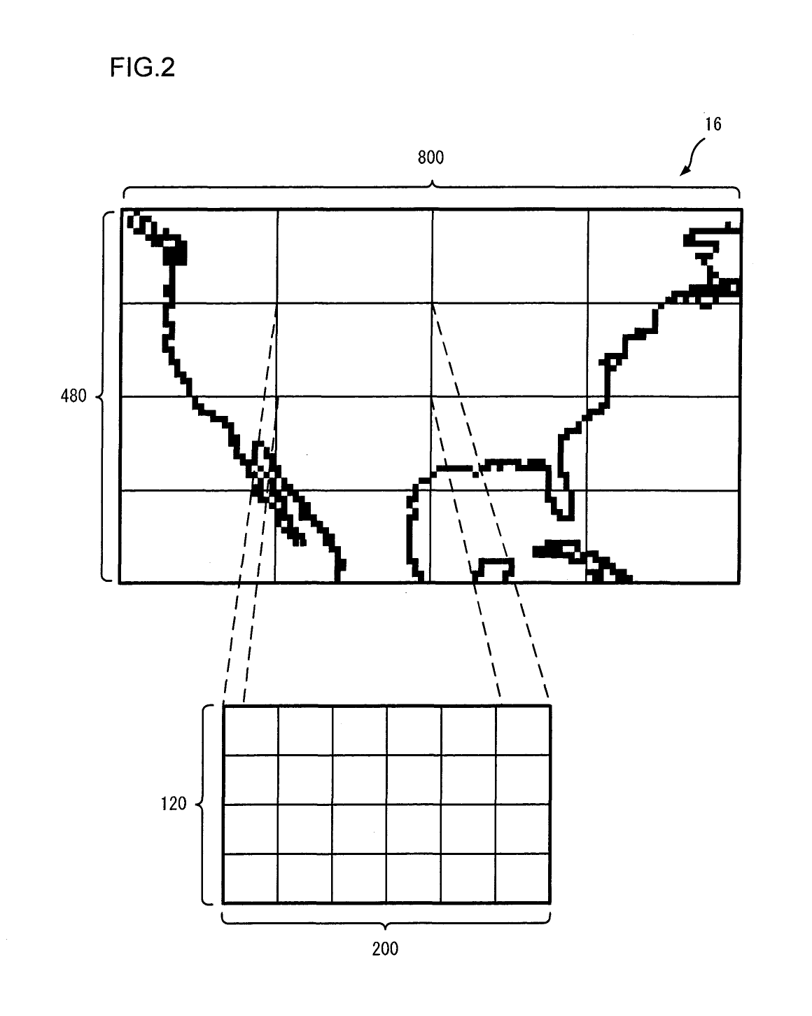

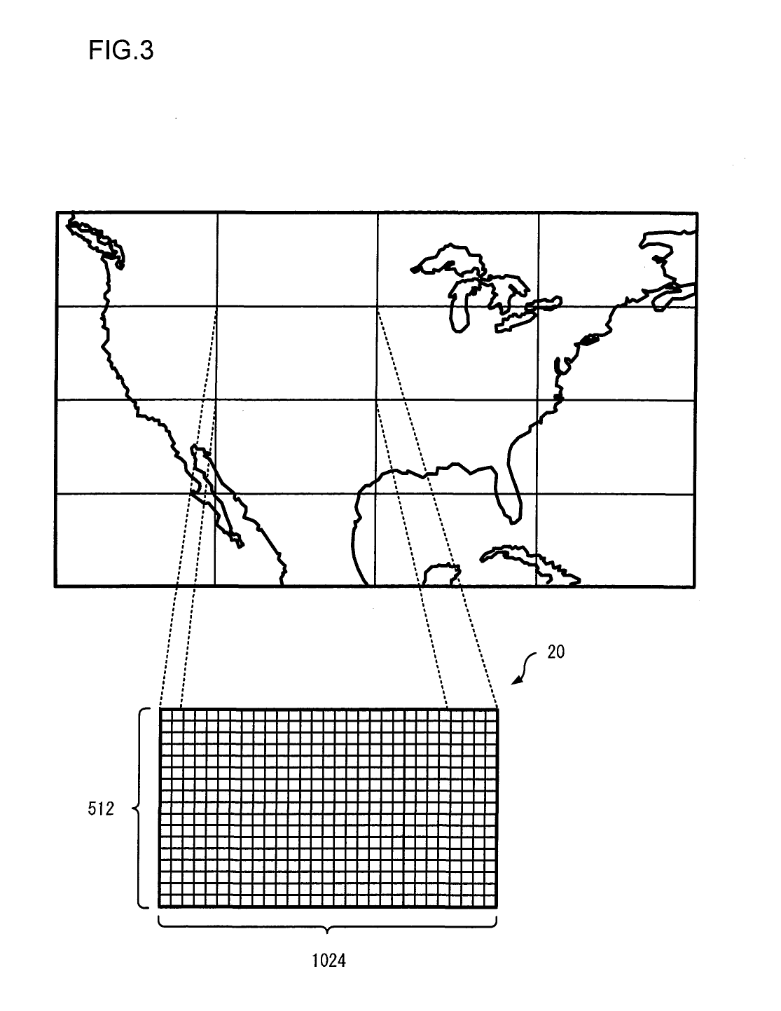

Various types of information including a map of an area around the subject vehicle position are provided, based upon various types of information such as map data, to the user as a screen display brought up at the display monitor 16. As shown in FIG. 2, the screen resolution at the display monitor 16 is 800×480 pixels. Accordingly, by dividing the display screen at the display monitor 16 into 4×4=16 equal parts, sixteen split screen areas each made up with 200×120 pixels are defined as shown in FIG. 2. It is to be noted that FIG. 2 shows a display screen with a resolution lower than the actual resolution so as to render each pixel distinct from other pixels. In order to demonstrate a clear difference from the resolution in FIG. 3, through the speaker 17, voice messages prompting the user to perform various types of input operations or providing route guidance to the user are output.

The input device 18, which includes operation keys operated by the user to select various command settings and the like, is constituted with button switches on an operation panel, hardware switches disposed around the panel and the like. In addition, the user operates the input device 18 to alter the scaling factor of the map on display at the display monitor 16. For instance, a scaling factor of the 1/50,000 map is “1/50000”. The user also sets a destination by manually operating the input device 18 in response to instructions provided on the display screen at the display monitor 16 or voice instructions output through the speaker 17. Furthermore, the user operates the input device 18 to select a specific satellite radio broadcast station.

Once a destination has been selected by the user, the navigation system 1 executes route calculation to determine a route to the destination based upon a specific algorithm by designating the current location detected via the current position detection device 14 as a start point. The route (hereafter referred to as a recommended route) thus determined is indicated on the screen display in a display mode distinguishable from other roads by, for instance, using a different display color. The user is thus able to identify the recommended route on the map on the screen display. In addition, the navigation system 1 guides the vehicle along the route by indicating to the user a specific direction along which the vehicle should advance through instructions provided on the screen or through voice instructions, so that the vehicle travels along the recommended route.

The touch panel 19 is a transparent touch switch laminated over the surface of the display monitor 15. An image brought up on display at the display monitor 16 is thus viewed through the touch panel 19. This also means that as the user touches the screen display brought up at the display monitor 16, the touch panel 19 is depressed. The touch panel 19 outputs a signal corresponding to an operating position at which the touch panel 19 has been depressed, to the touch panel control unit 110. The touch panel control unit 110 then calculates the depression position at which the touch panel 19 has been depressed.

As the user presses down on a specific button among various buttons, a display menu or the like on display at the display monitor 16 with his finger or the like, the touch panel 19, too, is depressed. In response, the processing defined in correspondence to the particular button or display menu is executed. In addition, as a specific point within a map on display at the display monitor 16 is touched, the touch panel 19 is also depressed at the corresponding position and the map is scrolled so as to set the depressed position at the center of the screen display at the display monitor 16.

The satellite radio reception unit 111 receives a satellite radio broadcast provided from a satellite radio station (not shown) via an artificial satellite and outputs the received satellite radio broadcast to the control circuit 11. The received satellite radio broadcast is output through the speaker 17. In addition, weather information provided in the satellite radio broadcast having been received at the satellite radio reception unit 111 is stored into the receiver memory 112.

The weather information provided in the satellite radio broadcast includes weather map information, extreme weather information on typhoons, hurricanes and the like, precipitation distribution information collected via weather radar, information on wind direction and wind strength observed at various observation points and the like. The weather map information may include, for instance, information indicating the position (latitude/longitude) of a high-pressure system or a low-pressure system, information indicating the position of a warm front or a cold front, isobaric chart information and barometric pressure information. The extreme weather information will include information indicating the positions of a typhoon, a hurricane, a tornado, an ice storm, a hail storm, a thunder storm and the like, information indicating the directions along which the extreme weather is moving and information predicting how the extreme weather is likely to advance. The precipitation distribution information indicates the position of an area experiencing rainfall, the rate of precipitation at the particular position and the like.

Weather information is provided through the satellite radio broadcast in correspondence to each of specific geographical areas. For instance, the United States of America is divided into 4×4=16 equal parts as illustrated in FIG. 3 and a satellite radio broadcast provides weather information collected in correspondence to the various geographical areas. In the following description, a given geographical area is referred to as a large tile. As shown in FIG. 3, each large tile 20 is further divided into 1024×512 areas in a mesh pattern and the weather information corresponding to the large tile 20 is divided in correspondence to the split mesh areas. The areas defined by further dividing the large tile 20 as described above are referred to as small tiles. It is to be noted that FIG. 3 shows a display screen with a resolution lower than the actual resolution so as to render each small tile as distinct from others. The satellite radio broadcast provides weather information by sequentially transmitting the weather information for the individual large tiles, i.e., the weather information for one large tile at a time, instead of transmitting the weather information for all the large tiles at once in a batch.

The receiver memory 112 is constituted with a rewritable non-volatile recording medium such as a flash memory or a hard disk. The weather information received via the satellite radio reception unit 111 is stored into the receiver memory 112. The weather information stored in the receiver memory 112 is displayed on a map in the form of icons, isobars, cold fronts or the like.

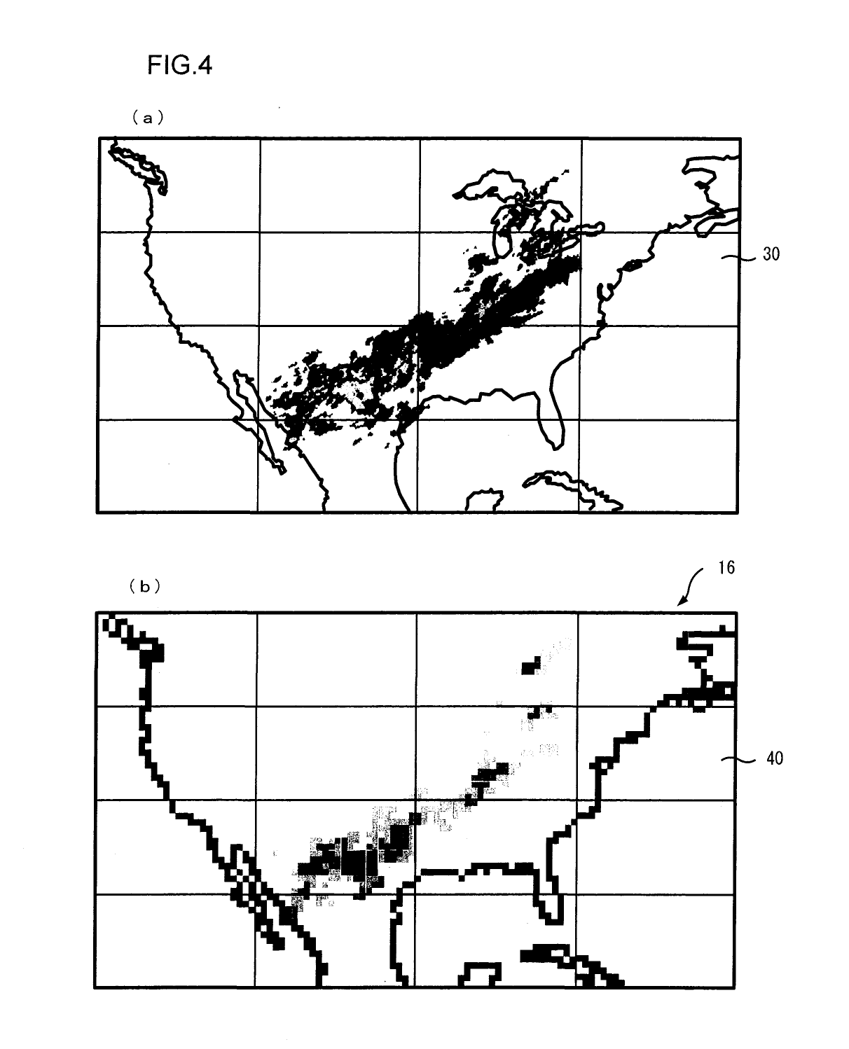

Next, in reference to FIG. 4, the precipitation display data processing executed in the embodiment of the present invention is described. FIG. 4(a) shows precipitation data included in the weather information having been received directly displayed over the map. The precipitation data indicate the precipitation per hour observed in each small tile. As explained earlier, one small tile is equivalent to one of the 1024×512 areas into which a large tile is divided. By displaying the precipitation data for the individual small tiles, a detailed precipitation distribution can be indicated over the map, as shown in FIG. 4(a).

FIG. 4(b) shows a map that would be brought up on display at the display monitor 16 with the precipitation distribution in FIG. 4(a) superimposed thereupon. The resolution of the reciprocation distribution displayed at the display monitor 16 would be lower than the resolution of the precipitation data in the weather information directly displayed over the map, since the screen resolution at the display monitor 16 is lower than the resolution of the precipitation distribution provided in the weather information. As shown in FIG. 2, each of the 4×4=16 split screen areas at the display screen of the display monitor 16 is made up with 200×120 pixels and thus, the precipitation distribution for each large tile must be displayed with the 200×120 pixels. However, since the precipitation data are available in correspondence to the individual small tiles, each large tile holds 1024×512 sets of precipitation data. This means that (5˜6)×(4˜5) sets of precipitation data will be allocated to each pixel.

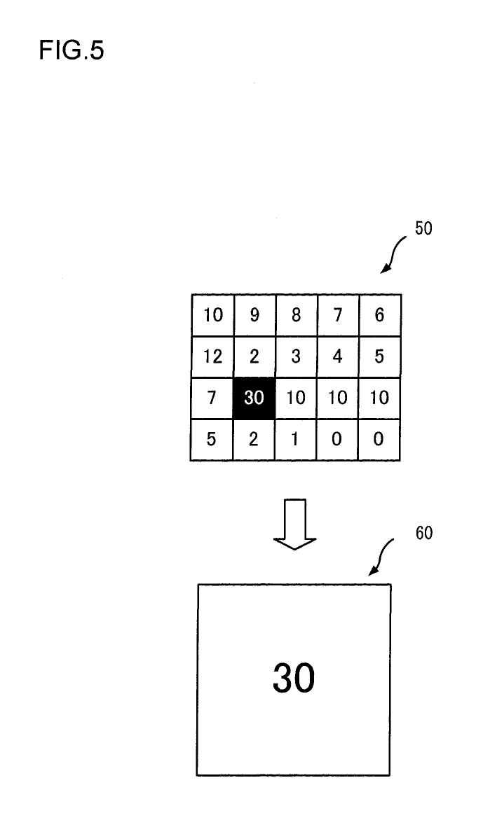

Only one set of precipitation information can be displayed for each pixel. Accordingly, a set of precipitation data among the (5˜6)×(4˜5) sets of precipitation data 50 corresponding to a given pixel, which indicates the largest value, is displayed at the corresponding single pixel 60, as shown in FIG. 5, through the precipitation display data processing executed in the embodiment of the present invention. In the example, the largest value among the values indicated by the sets of precipitation data 50 corresponding to the particular pixel is 30 mm. Accordingly, the precipitation “30 mm” is displayed for the pixel 60. The weather information for each large tile is thus brought up on display at the display monitor 16. Since precipitation data representing the (5˜6)×(4˜5) sets of precipitation data are displayed at each pixel, as described above, the resolution of the precipitation distribution displayed at the display monitor will be lower than the resolution of the precipitation data in the weather information directly displayed over the map.

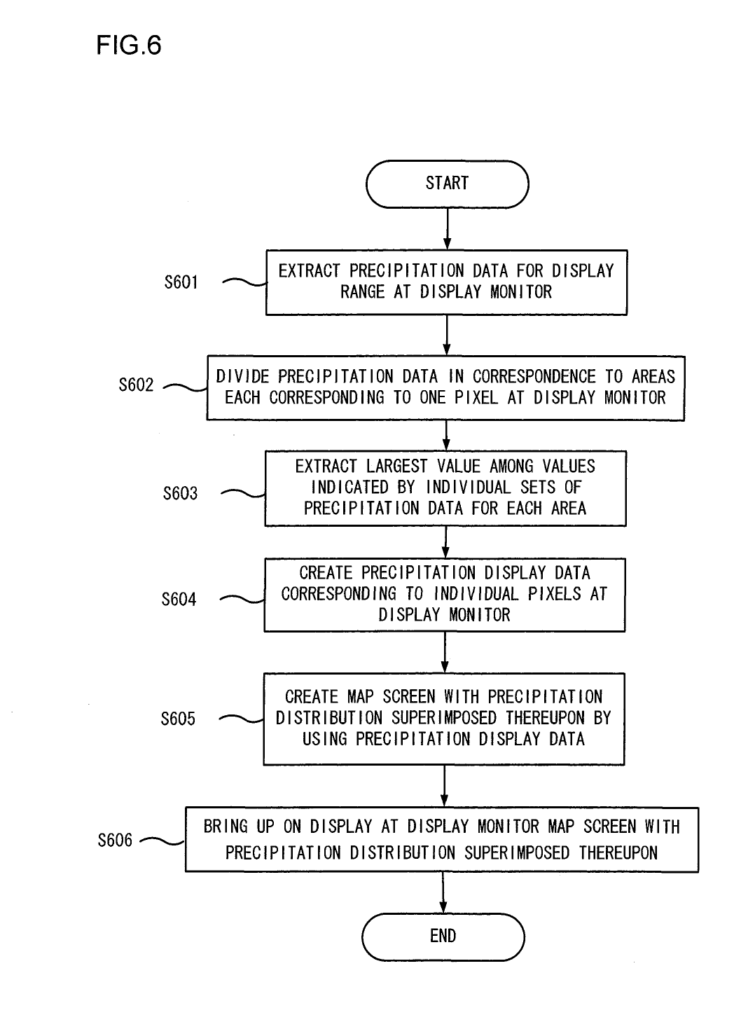

Next, in reference to the flowchart presented in FIG. 6, the precipitation display data processing executed in the embodiment of the present invention is described. The processing in FIG. 6 is executed by the control circuit 11 based upon a program started up as “display precipitation data” is selected from a menu (not shown).

In step S601, the precipitation data corresponding to the display range of the display monitor 16 are extracted from the weather information stored in the receiver memory 112. In step S602, the precipitation data are divided into portions each relevant to one of the areas corresponding to the individual pixels at the display monitor 16. In step S603, the precipitation data indicating the largest value among the sets of precipitation data corresponding to each pixel are extracted. In step S604, precipitation display data corresponding to the pixels at the display monitor 16 are created based upon the largest values having been extracted. In step S605, image data of a map screen with a precipitation distribution superimposed thereupon are created based upon the precipitation display data. In step S606, the map screen with the precipitation distribution superimposed thereupon is brought up on display at the display monitor 16.

The navigation system 1 in the embodiment of the present invention described above achieves the following advantages.

If precipitation data for a plurality of geographical areas are available over a map area corresponding to a single pixel at the display monitor, the precipitation in the geographical area with the precipitation data indicating the highest level of precipitation, among the sets of precipitation data for the plurality of geographical areas, is indicated at the particular pixel. As a result, the processing for displaying detailed weather information by superimposing the information over a wide-range map can be executed quickly. In addition, the highest level of precipitation indicated on the map provides a warning for the user.

The embodiment described above allows for the following variations.

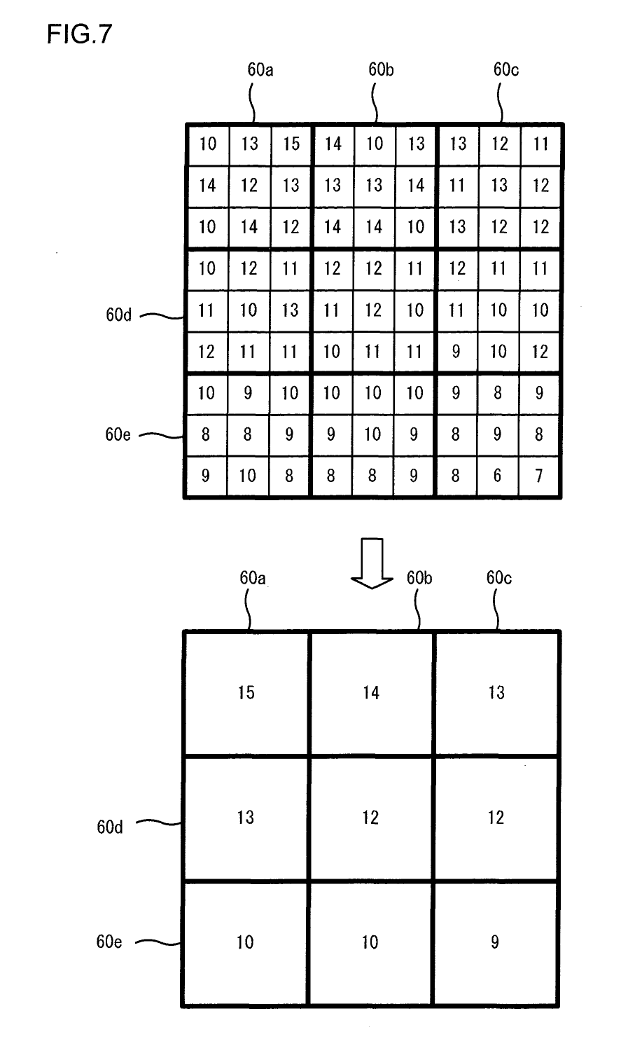

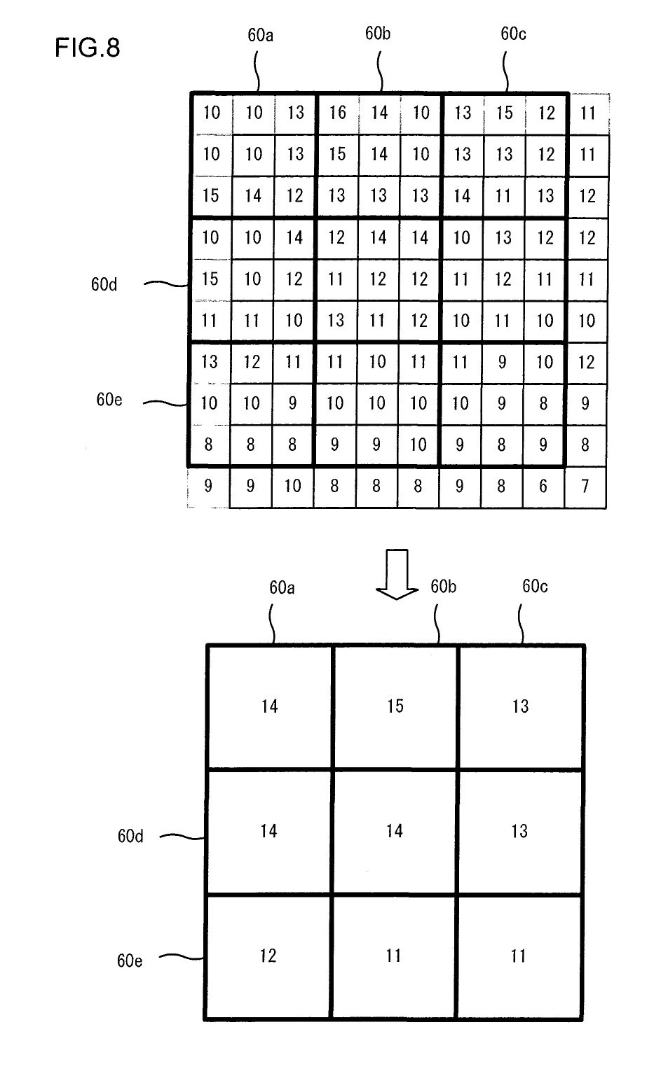

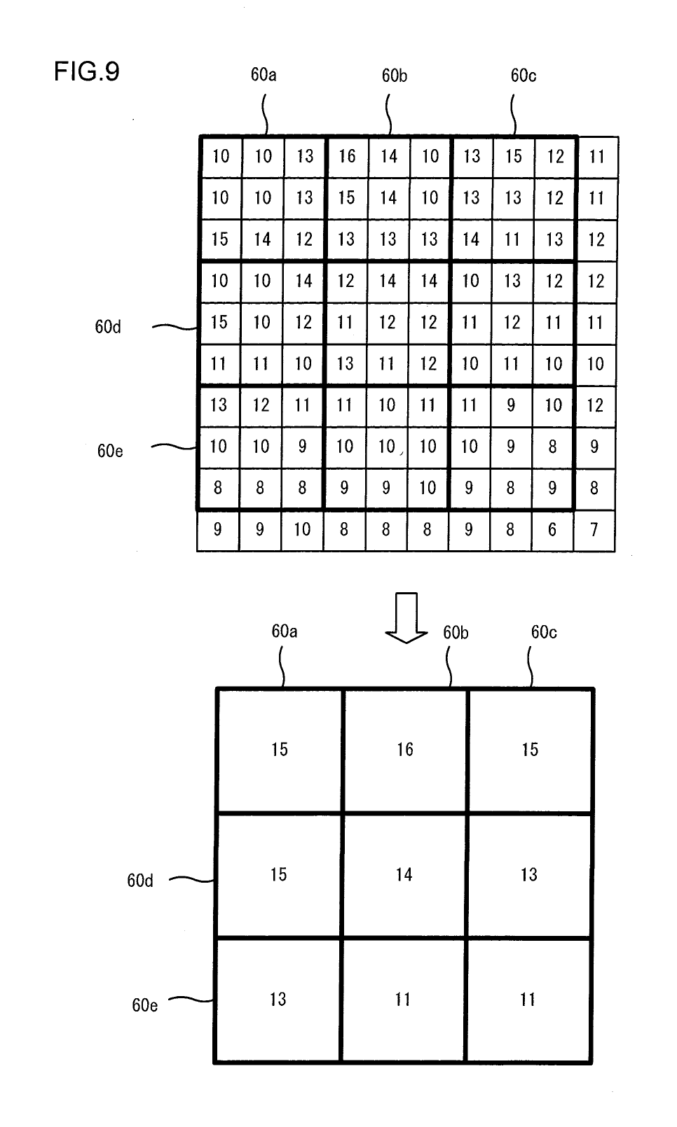

(1) While scrolling a map displaying a precipitation distribution, the precipitation distribution may be displayed by using the precipitation data having already been extracted alone, without extracting precipitation data corresponding to the map display range newly brought up at the display monitor 16 from the weather information stored in the receiver memory 112. Through these measures, the precipitation distribution can be displayed even as the map is scrolled. For instance, precipitation data for 3×3 small tiles may be available in correspondence to each of pixels 60a˜60e, as shown in FIG. 7. If no precipitation data are further extracted from the weather information stored in the receiver memory 112 as the map is scrolled, the number of sets of precipitation data allocated in the small tiles present in the area corresponding to the pixel 60a will be reduced to four and the number of sets of precipitation data for the small tiles present in the areas corresponding to the pixels 60b˜60e will each be reduced to six, as shown in FIG. 8. Under these circumstances, the highest level of precipitation among the precipitation levels corresponding to the four small tiles will be displayed for the pixel 60a and also, the highest level of precipitation among the precipitation levels corresponding to the six small tiles will be displayed for each of the pixels 60b˜60e. Once the map has been completely scrolled, the precipitation data for the map display range displayed at the display monitor 16 will be extracted from the weather information stored in the receiver memory 112, as shown in FIG. 9, so as to indicate the highest level of precipitation among the precipitation levels corresponding to the nine small tiles for each of the pixels 60a˜60e.

(2) The weather information to be superimposed over the map on display is not limited to precipitation per unit time. For instance, weather information indicating temperature, humidity, cumulative precipitation, duration of sunlight per unit time, barometric pressure, humidity, wind direction, wind speed or the like, instead. In such a case, too, even when weather information for a plurality of geographical areas is allocated to a map area corresponding to a single pixel at the display monitor 16, the processing for displaying detailed weather information by superimposing it over a wide-range map can be executed speedily by displaying the weather information for the geographical area with weather information thereof indicating the largest weather information numerical value among the plurality of sets of weather information for the plurality of geographical areas as representative weather information for the particular pixel.

(3) The present invention may be adopted in a different type of map display device other than the navigation system 1. For instance, weather information may be displayed as described above on a portable telephone having map display capability.

The embodiment described above simply represents an example and the present invention is in no way limited to the embodiment.

1. A map display device comprising:
a map display control unit that displays a map at a display monitor;
a weather information reception unit that receives weather information; and
a weather information display control unit that displays the received weather information by superimposing the weather information over the map, wherein:
if a plurality of sets of weather information for a plurality of geographical areas are allocated to a map area corresponding to a single pixel at the display monitor, the weather information display control unit displays a set of weather information for a geographical area at the single pixel, the set of weather information for the geographical area having a largest weather information numerical value, among the plurality of sets of weather information for the plurality of geographical areas.

2. A map display device according to claim 1, further comprising:
a weather information extraction unit that extracts weather information for a display range of the display monitor among the weather information received at the weather information reception unit, wherein:
the weather information display control unit displays weather information superimposed over the map based upon the extracted weather information, and displays weather information superimposed over the map based upon weather information having been extracted while the map is being scrolled.

3. A map display device according to claim 1, wherein:
the weather information indicates cumulative precipitation, wind direction, wind speed, temperature, humidity, duration of sunshine per unit time, or barometric pressure.

4. A map display device according to claim 2, wherein:
the weather information indicates cumulative precipitation, wind direction, wind speed, temperature, humidity, duration of sunshine per unit time, or barometric pressure.

5. A map display device according to claim 2, wherein:
while the map is being scrolled, the weather information extraction unit extracts no weather information for the display range of the display monitor and the weather information display control unit displays weather information superimposed over the map based upon weather information that has been extracted by the weather information extraction unit before the map is being scrolled.
